(19) United States
(12) Patent Application Publication
(10) Pub. No.: US 2026/0365568 A1
(43) Pub. Date: Nov. 19, 2026

(54) VACUUM INSULATED GLASS CONTAINING HIGH-STRENGTH, TRANSMISSIVE PILLARS AND METHOD OF MAKING THEREOF

(71) Applicant: LUXWALL, INC., Ypsilanti, MI (US)

(72) Inventor: Scott V. THOMSEN, Ypsilanti, MI (US)

(73) Assignee: LUXWALL, INC., Ypsilanti, MI (US)

(21) Appl. No.: 19/132,517

(22) PCT Filed: Nov. 22, 2023
(86) PCT No.: PCT/US2023/081004

§ 371 Date: May 23, 2025

Related U.S. Application Data
(60) Provisional application No. 63/427,656, filed on Nov. 23, 2022.

(51) Int. Cl. C03C 21/00; C03C 3/087; C03C 3/091; C03C 3/097

(52) U.S. Cl. CPC C03C 21/002; C03C 3/087; C03C 3/091; C03C 3/097

(57) ABSTRACT

The present disclosure provides chemically strengthened pillars, vacuum insulated glass units or panels comprising the pillars, and methods of chemically strengthening glass pillars. In an embodiment, a vacuum insulating unit with a plurality of substantially transparent, chemically strengthened glass inclusive spacers or pillars are provided between the opposing transparent substrates. The translucent characteristics of the spacers/pillars enable them to be more aesthetically pleasing, while at the same time being strong enough to support the opposing substrates and withstand the applicable forces of atmospheric pressure. The high compressive strength of the chemically strengthened glass pillars using double ion exchange processes enable them to be placed farther apart than traditional vacuum insulating unit pillars thereby improving the insulation resistance of the vacuum insulating unit and thereby reducing manufacturing costs.

### CROSS-REFERENCE TO RELATED APPLICATION

This application claims the benefit of U.S. Provisional Patent Application No. 63/427,656, filed Nov. 23, 2022, the disclosure of which is hereby incorporated by reference in its entirety.

### FIELD OF INVENTION

The present invention is generally directed to vacuum insulated devices, and more particularly to a vacuum insulated device containing a high-strength, transparent pillar and method of making thereof.

### BACKGROUND

A vacuum insulating unit provides thermal insulation resistance by reducing or eliminating convective energy between the two transparent substrates, reducing conductive energy transfer between the two transparent substrates, and reducing radiative energy. Some vacuum insulating units can include an outboard transparent substrate, inboard transparent substrate, a hermetic perimeter edge seal, a sorption getter, a pump-out port and pillars sandwiched between the two outer transparent substrates. The transparent substrates can be glass or glass variants, plastic or plastic variants or alternative transparent materials.

Certain metal-based pillar materials and thermal processing have been developed for vacuum insulated glasses. Metal-based pillars were selected for their ductility, Mohs hardness, bulk compression under 1×10−7 torr vacuum loads, and ability to shape the pillars. Drawbacks of metal-based pillars include that they cannot support vacuum stress loading beyond a separation distance of 40 mm for a 0.5 mm diameter pillar, have a different coefficient of thermal expansion (CTE) than the opposing glass substrates (15×10⁻⁶ to 20×10⁻⁶ for metal versus 9.0×10⁻⁶ for soda lime glass substrates), and are opaque (visible) in the glazing unit. The closer the pillars are placed inside the vacuum cavity the higher the u-factor due to conduction energy losses from one glass substrate to the other glass substrate through the metal-based pillars. The thermal mismatch between the glass substrates and metal pillars is magnified under asymmetric thermal loading conditions, for example −30 degrees C on the exterior of the window and +25 degree C on the interior of the window. The movement of the interior and exterior glass substrates combined with the pillar to glass substrate CTE delta results in the pillar moving in the x, y, and z directions. As the pillar moves due to vacuum insulating unit thermal conditions the pillar creates micro-cracks in the glass substrates. The metal pillar Youngs Modulus is 2.8 times greater than the glass substrates, and the shear modulus is 2 times greater than the glass substrates. It is preferred to have a pillar material that closely matches the CTE of the substrates.

The diameter of the metal-based pillar can be increased from about 1.0 mm to 1.5 mm at the expense of being more visible and negatively impacting the vacuum insulating glass u-factor due to the increased pillar surface area leading to higher heat transfer between the two glass substrates. The vacuum insulated glass u-factor increases from 0.25 W/mK with a pillar radius of 0.25-mm to 0.55 W/mK with a pillar radius of 0.75-mm. The most common metal pillar material is annealed stainless steel with a thermal conductivity of 14.6 W/mC versus soda lime glass substrates with a thermal conductivity of 1.08 W/mC.

An example drawback of metal spacers/pillars is that they often cannot support vacuum stress loading beyond a given spacer separation distance, such as a spacer separation distance of about 40 mm for a 0.5 mm diameter spacer/pillar. Finite element modeling signals that a stainless steel pillar should have a pillar spacing of about 40-mm and not greater than 50-mm due to the shear modulus, elastic shear stiffness, being about 74 GPa to about 81 GPa, Youngs Modulus, material stiffness, being about 200 GPa, and compressive stress being about 205 MPa to about 310 MPa, A stainless steel pillar with a pillar spacing of 40-mm under 1E-7 torr vacuum loads can experience 1,286 MPa of induced stress in the pillar, Von Mises stress, and at 60-mm an induced stress of 2,107 MPa. The stainless-steel pillar will undergo plastic deformation of the pillar thickness and contribute to increased glass deflection between the pillars because the compressive strength of the stainless pillar is about 510 MPa and the pillar to glass interface can reach stress levels as high as 975 MPa under wind load and asymmetric thermal shock conditions. The modulus of rupture of stainless steel is about 205 MPa to about 310 MPa which is well below the induced tensile and Von Mises stresses induced under vacuum loads. A stainless-steel pillar array with 60-mm pillar spacing under 1E-7 torr vacuum loads will experience micro-cracking at the glass substrate to pillar interface due to a materials mismatch in Youngs Modulus, shear modulus, and tensile strength. It is preferred to have a pillar with a compressive strength approaching 900 MPa to handle the vacuum load induced stress conditions.

Certain transparent pillar materials have been developed for vacuum insulated glasses. Most previous transparent pillar attempts used materials with a high Mohs hardness to increase the compressive stress to increase the pillar separation. The drawback of such materials, such as limited to quartz, sapphire, and aluminum oxide, is the high Mohs hardness of the bulk material. Most of these materials have a Mohs hardness of about 8.0 to about 9.5 compared to 5.0 to 5.5 for soda lime float glass. When the vacuum insulated glass unit is exposed to asymmetric thermal shock on the order of 50 degrees C to 90 degrees C, the opposing glass substrates move in opposite directions which causes the pillars to move between the two lites. The movement of the pillars can induce hertzian cracks in the glass substrates due to the pillar hardness being significantly higher than the glass substrates. The rate of glass cracking and breakage is increased if the high hardness pillar contains a surface defect or the opposing glass substrates contain a surface or bulk defect.

Therefore, a need exists in the field for a high-strength, transparent pillar for vacuum insulated glass, wherein the pillar has about the same Mohs hardness as the glass substrates, similar to a metal-based pillar, to minimize or reduce hertzian cracks, a CTE closely approximating the opposing glass substrates minimizing pillar movement during thermal exposure, the pillar has a thermal conductivity about equal to the opposing glass substrates, a compressive surface stress sufficient to support loading under 1×10⁻⁷ torr vacuum pressure, sufficient plastic deformation, and a compressive surface stress to central tension region stress ratio to minimize pillar defects or rupture under load.

### SUMMARY

To address these and related challenges and meet the noted needs, the present disclosure provides chemically strengthened pillars, vacuum insulated glass unit comprising the pillars, and methods of chemically strengthening glass pillars.

Accordingly, in an aspect, the present disclosure provides a spacer comprising chemically strengthened glass that is substantially transparent to at least certain wavelengths of visible light. In an embodiment, the spacer comprises one or more of the following characteristics: a compressive surface stress in a range of about 700 MPa to about 1,000 MPa, a depth of layer in a range of about 5 um to about 20 um, a depth of compression in a range of about 40 um to about 80 um, a central tension maximum stress in a range of about 40 MPa to about 80 MPa, a Mohs hardness of less than 6.0, and a Csk in a range of about 65 MPa to about 200 MPa.

In another aspect, the present disclosure provides a thermally insulating glass panel. In an embodiment, the thermally insulating glass panel comprises one or more spacers according to any embodiment of the present disclosure. In an embodiment, the thermally insulating glass panel comprises a first glass substrate; a second glass substrate, wherein the first glass substrate and the second glass substrate are positioned to define a low-pressure space therebetween, the low-pressure space comprising a pressure less than atmospheric pressure; a plurality of spacers according to any embodiment of the present disclosure disposed between the first glass substrate and the second glass substrate in the low-pressure space, wherein the plurality of spacers is configured to provide strength sufficient to maintain separation of the first glass substrate and the second glass substrate without inducing cracks in a glass substrate surface of the first glass substrate and the second glass substrate; and a hermetic edge or peripheral seal comprising at least one sealing material.

In another aspect, the present disclosure provides a method of chemically strengthening a glass spacer. In an embodiment, the method comprises contacting the glass spacer with a first salt bath at a first salt bath temperature and for a first salt bath time sufficient to replace lithium ions in the glass spacer with potassium and sodium ions, and contacting the spacers with a second salt bath at a second salt bath temperature and for a second salt bath time sufficient to replace lithium ions in the glass spacer with potassium ions and sodium ions. In an embodiment, the first salt bath comprises a salt bath ratio of about 55% to about 70% potassium nitrate (KNO₃) to about 30% to about 45% sodium nitrate (NaNO₃), wherein the first salt bath temperature is in a range of about 370 degrees C to about 450 degrees C, wherein the first salt bath time is in a range of about 90 minutes to about 150 minutes. In an embodiment, the second salt bath comprises a salt bath ratio of about 85% to about 98% potassium nitrate (KNO₃) to about 2% to about 15% sodium nitrate (NaNO₃), wherein the second salt bath temperature is in a range of about 360 degrees C and 450 degrees C, and wherein a second salt bath time is in a range of about 20 minutes to about 80 minutes.

In another aspect, the present disclosure provides a glass spacer chemically strengthened according to a method according to any embodiment of the present disclosure.

In another aspect, the present disclosure provides a thermally insulating glass panel comprising a glass spacer made according to any method of the present disclosure. In an embodiment, thermally insulating glass panel comprises a first glass substrate; a second glass substrate, wherein the first glass substrate and the second glass substrate are positioned to define a low-pressure space therebetween, the low-pressure space comprising a pressure less than atmospheric pressure; a plurality of spacers made according to any method of the present disclosure disposed between the first glass substrate and the second glass substrate in the low-pressure space, wherein at least some spacers of the plurality of spacers comprise include chemically strengthened glass that is substantially transparent to at least certain wavelengths of visible light and configured to provide strength sufficient to maintain separation of the first glass substrate and the second glass substrate without inducing cracks in a glass substrate surface of the first glass substrate and the second glass substrate; and a hermetic edge or peripheral seal comprising at least one sealing material.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the subject matter of the present disclosure will become more readily appreciated as the same become better understood by reference to the following detailed description, when taken in conjunction with the accompanying drawings, wherein:

FIG. 1 is a schematic side cross sectional view of a vacuum insulating unit according to embodiments of the present disclosure;

FIG. 2 is cross sectional view of a transparent pillar according to embodiments of the present disclosure, wherein the pillar has a compressive stress layer at each surface of the pillar and a central tension layer;

FIG. 3 is a cross sectional view of the stress profile of a transparent pillar according to embodiments of the present disclosure, wherein the pillar has a surface compressive stress (CS) at each surface, a depth of compression (DOC), a maximum central tension point (Max CT) and a defined stress profile that is symmetric about the maximum central tension (CT) point;

FIG. 4 is a cross sectional view of the stress profile sections for a transparent pillar according to embodiments of the present disclosure, wherein the pillar has a compressive stress region at each substrate surface defined as CS1 and CS2; and

FIG. 5 is a cross sectional view of the stress profile for a transparent pillar according to embodiments of the present disclosure, wherein the pillar has a depth of layer for potassium concentration, a DOC for sodium concentration, a knee point where there is an inflection point or change in slope of the stress profile and a corresponding compressive stress at the knee point (CSk).

### DETAILED DESCRIPTION

In various aspects, the present disclosure provides chemically strengthened pillars, vacuum insulated glass units or panels comprising the pillars, and methods of chemically strengthening glass pillars. As described further herein, the chemically strengthened pillars of the present disclosure are optically transmissive, such as in a visible light range, and have sufficient compressive surface stress and other properties to strength to support the mechanical force induced by the opposing substrates at low pressures associated with vacuum insulated glass units.

In an aspect, the present disclosure provides a spacer comprising chemically strengthened glass that is substantially transparent to at least certain wavelengths of visible light.

In an embodiment, the pillars of the present disclosure have been chemically strengthened or are otherwise configured to balance compressive surface stress and central tension stress of the pillars. In an embodiment, ion exchange, such as at a temperature below the Tg of glass, introduces compression in the surface layers of the treated glass. Such compression reinforces the glass. This surface compression due to ion exchange can compensate in part for the stress applied to a surface of the chemically strengthened glass.

Without wishing to be bound to any particular theory, it is believed that chemical strengthening, such as described further herein with respect to salt baths, includes replacing ions initially present in the glass, such as lithium ions, with larger ions, such as sodium, potassium, rubidium, etc., thereby inducing compressive stress forces on the surface of the chemically strengthened glass. Such compressive stress forces can result in glass pillars or spacers configured to withstand the stresses related to vacuum insulated glass units, described further herein. As also described further herein, such compressive stress may also be generally balanced with a central tension of the chemically strengthened pillar to provide an exceptionally strong glass pillar that is also optically transmissive.

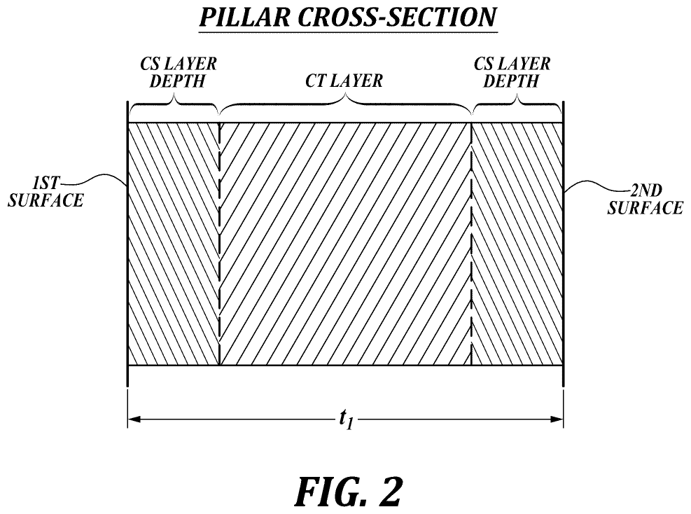

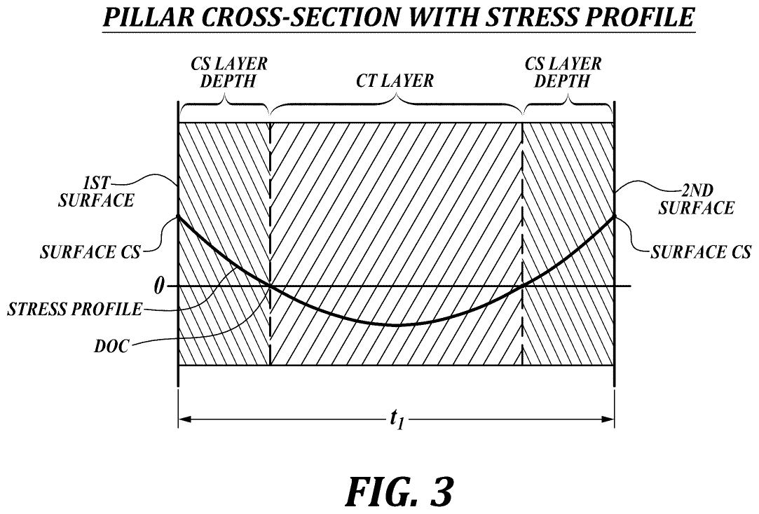

FIG. 2 is cross-sectional view of a transparent pillar according to embodiments of the present disclosure, wherein the pillar has a compressive stress layer at each surface of the pillar and a central tension layer. FIG. 3 is a cross sectional view of the stress profile for the transparent pillar, wherein the pillar has a surface compressive stress (CS) at each surface, a depth of compression (DOC), a maximum central tension point (Max CT) and a defined stress profile that is symmetric about the maximum central tension (CT) point.

In an embodiment, the relationship between compressive surface stress (CS) and central tension stress (CT) can approximated by the expressions: CT=(CS×DOL)/(t−(2×DOL)) or CT=(CS×DOL)/(t−(1.5×DOL)), where t is the thickness, expressed in microns (um), of the pillar. In various sections of the disclosure, central tension (CT) and compressive stress (CS) are expressed herein in MPa, thickness t can be expressed in microns (um), and depth of layer (DOL) is expressed in microns (um).

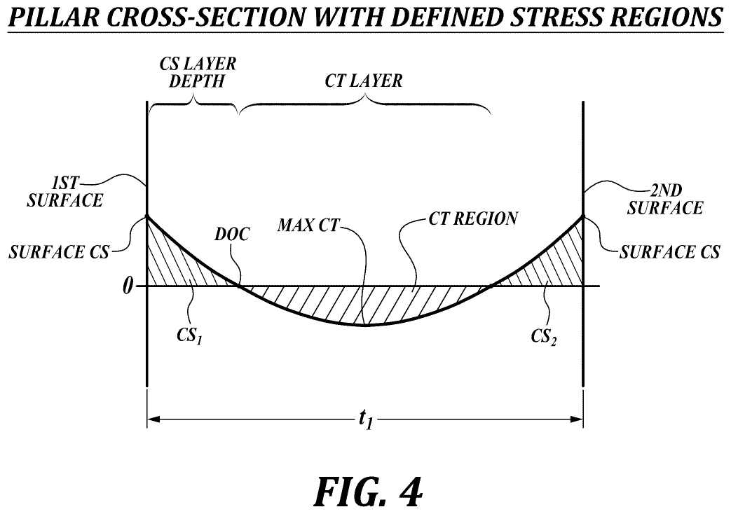

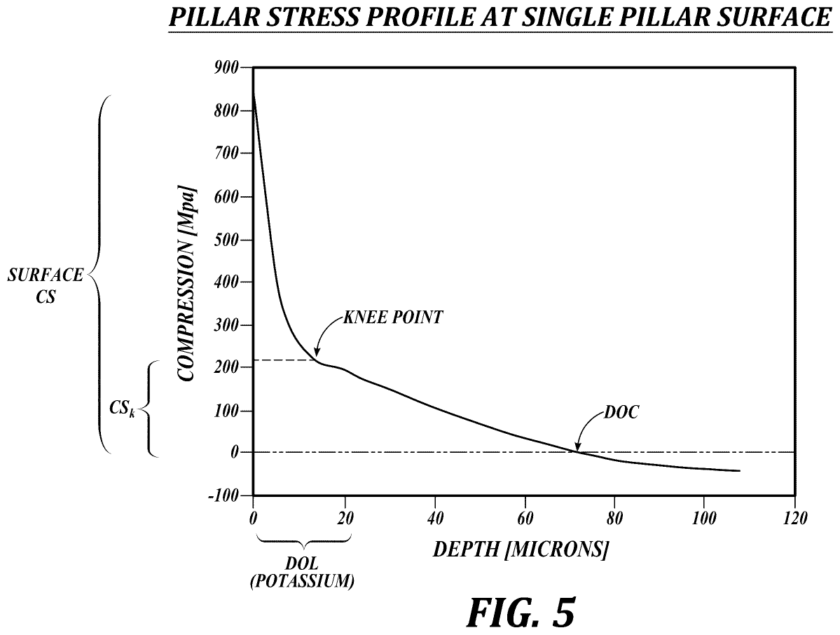

To illustrate this concept, FIG. 4 provides a cross sectional view of the stress profile sections for a transparent pillar, wherein the pillar has a compressive stress region at each substrate surface defined as CS1 and CS2. As shown in FIG. 5, a depth of layer of an ion inserted into a pillar (here potassium) can affect a compressive surface stress of the pillar, such as by defining, at least in part, a knee point in the compressive stress profile. As used herein, a “knee point” is an inflection point or change in slope of the stress profile and a corresponding compressive stress at the knee point (CSk). Such knee points can be the result of two or more ion exchange processes or steps and are not generally found in glass that has been processed by a single ion exchange process.

The relationship between CS and CT is important in enhancing pillar stress and plastic deformation to ensure the pillar has sufficient strength to support the mechanical force induced by the opposing substrates at 1×10⁻⁷ torr cavity pressure. The CS to CT ratio is enhanced or optimized by adjusting a ratio of, for example, sodium nitrate to potassium nitrate, salt bath temperature, salt bath immersion time, and use of a pre-heat or pre-treatment step for each ion exchange process step. The ratio of potassium nitrate to sodium nitrate directly can impact the rupture strength of the glass pillar.

In an embodiment, the spacer comprises one or more of the following characteristics: a compressive surface stress in a range of about 700 MPa to about 1,000 MPa, a depth of layer in a range of about 5 um to about 20 um, a depth of compression in a range of about 40 um to about 80 um, a central tension maximum stress in a range of about 40 MPa to about 80 MPa, a Mohs hardness of less than 6.0, and a Csk in a range of about 65 MPa to about 200 MPa.

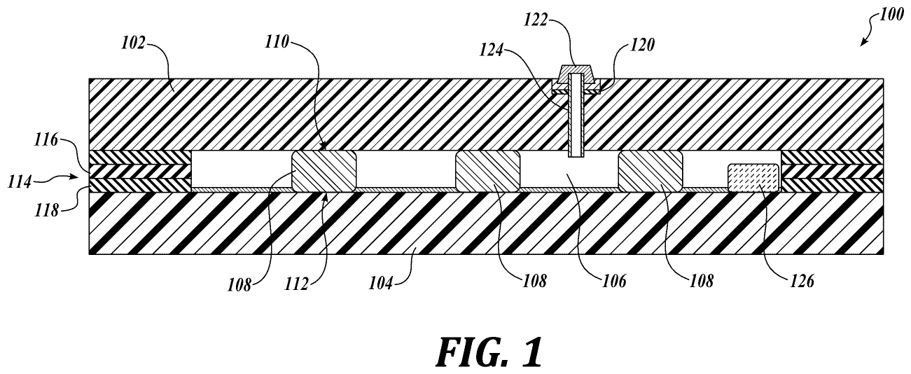

In an embodiment, the spacers of the present disclosure comprise an amorphous glass material, such as an amorphous glass material comprising a coefficient of thermal expansion configured to match or approximately match a coefficient of thermal expansion of a glass substrate, such as a first glass substrate and/or second glass substrate discussed further herein with respect to the thermally insulating glass panel 100 discussed further herein with respect to FIG. 1.

In certain embodiments, the glass pillar is disc-shaped and sidewall profile is modified prior to chemical strengthening to reduce the probability of glass substrate damage during asymmetric thermal stress conditions by rounding the edges of the disc via mechanical tumbling using metal oxide polishing or milling compounds or agents. In an embodiment, the radii of curvature of the glass pillar sidewall is optimized or otherwise modified to reduce the occurrence of hertzian cracks in the glass substrates, such as under 1×10⁻⁷ torr pressure.

In an embodiment, the spacer defines a shape selected from the group consisting of spherical, cylindrical, square, rectangular, rod-like, bead-like, disc-like, oval, trapezoidal, or combinations thereof. In an embodiment, a spacer diameter or spacer width is at least about 1.8 times larger than a spacer height. In an embodiment, a spacer diameter or spacer width is at least about 0.20 mm to about 1.0 mm, and wherein a spacer height is at least about 0.10 mm to about 0.5 mm. In an embodiment, the spacer is a disc-shaped device with a diameter of at least about 0.4-mm with a thickness of at least about 0.25-mm.

In preferred embodiments, the pillar is a disc-shaped device with a diameter of at least about 0.4-mm with a thickness of at least about 0.25-mm. In other embodiments, the pillars may take different shapes. For example, the pillar may be spherical, cylindrical, square, rectangular, rod-like, bead-like, oval, trapezoidal, or the like. The pillar diameter or width is at least about 0.20-mm to about 1.0-mm and the pillar height is at least about 0.10 mm to about 0.5 mm. The pillar edges may be rounded or eased to minimize or reduce cracking in the opposing glass substrates of the vacuum insulating unit during pillar movement.

In various embodiments, the glass pillars of the present disclosure are visibly unobtrusive, and more aesthetically pleasing than conventional opaque spacers/pillars, such as metal-based or ceramic pillars. In this regard, their optical transmissive properties, similar to soda lime silicate glass, allow the spectral transmission of a large portion (all in certain embodiments) of visible wavelengths of light (e.g., light in a range of about 400 nm to about 700 nm) as compared to opaque metal and ceramic pillars.

Background illumination conditions, both day and night, will thus alter the tint of spacers/pillars to a shade or tint more closely matched to the background itself (i.e., the background is the area behind a vacuum insulating unit, which is viewer is looking through the vacuum insulating unit so the pillars blend into the surrounding environment more easily than opaque pillars). In an embodiment, the glass pillars have an index of refraction of about 1.50, which closely approximates the index of refraction of the soda lime silicate glass outer substrates comprising the vacuum insulating unit.

In an embodiment, the chemically strengthened glass pillars comprise low light absorption properties due to the low iron or iron oxide content in the chemically strengthened glass pillar. In an embodiment, the glass pillar has an extinction coefficient of about no greater than 0.010, which enables the pillars to be translucent or otherwise transmissive in the visible light spectrum (e.g., from about 400 nm to about 700 nm).

In certain embodiments, the pillar comprises an amorphous glass material. In an embodiment, the amorphous glass material comprises the following elements with about the defined weight percentages: SiO₂—62.132%; Al₂O₃—32.340%; P₂O₅ —4.780%; ZnO—0.650%; K₂O—0.025%; Fe₂O₃—0.021%; CaO—0.014%; SnO₂—0.013%; and trace amounts of LiO₂; ZrO₂; Ga₂O₃; MnO; CuO; and Rb₂O. In an embodiment, the amorphous glass material comprises: SiO₂ in a range of about 60.0 wt % to about 64.0 wt %; Al₂O₃ in a range of about 29.0 wt % to about 36.0 wt %; P₂O₅ in a range of about 3.0 wt % to about 6.0 wt %; ZnO in a range of about 0.0 wt % to about 2.0 wt %, K₂O in a range of about 0.0 wt % to about 1.0 wt %; and Fe₂O₃ in a range of about 0.0 wt % to about 1.0 wt %. In an embodiment, the amorphous glass material comprises a coefficient of thermal expansion in a range of about 7.8×10⁻⁶ to 9.2×10⁻⁶ per degree C; a softening point in a range of about 750 degrees C to 900 degrees C; a glass transition temperature in a range of about 500 degrees C to 650 degrees C; and an annealing point in a range of about 540 degrees C to 650 degrees C. In an embodiment, the aluminosilicate pillar elemental composition is configured to closely match the coefficient of thermal expansion of soda lime silicate vacuum insulating unit glass substrates, such as those described further herein with respect to FIG. 1.

In certain embodiments, the pillar comprises an amorphous glass material comprising the following components with about the defined weight percentages: SiO₂-69.98%; Li₂O—7.87%; Al₂O₃—7.41%; MgO—7.12%; Na₂O—5.22%; ZrO₂—1.04%; K₂O—0.97%; CaO—0.250%; and TiO₂—0.13%. In an embodiment, the amorphous glass material comprises: SiO₂ in a range of about 66.0 wt % and about 72.0 wt %; Li₂O in a range of about 5.0 wt % to 9.0 wt %; Al₂O₃ in a range of about 5.0 wt % to 10.0 wt %; MgO in a range of about 5.0 wt % to 10.0 wt %; Na₂O in a range of about 3.0 wt % to about 7.0 wt %; ZrO₂ in a range of about 0.0 wt % to about 3.0 wt %; K₂O in a range of about 0.0 wt % to about 4.0 wt %; CaO in a range of about 0.0 wt % to 2.0 wt %; and TiO₂ in a range of about 0.0 wt % to about 3.0 wt %. In an embodiment, the amorphous glass pillar comprising the defined composition is a lithia aluminosilicate (LAS) glass material comprising a coefficient of thermal expansion in a range of about 7.0×10⁻⁶ to 8.8×10⁻⁶ per degree C; a softening point in a range of about 770 degrees C to 920 degrees C; a glass transition temperature in a range of about 500 degrees C to 620 degrees C; and an annealing point in a range of about 550 degrees C to 650 degrees C. The lithia aluminosilicate pillar elemental composition is optimized or otherwise configured to match or approximate the coefficient of thermal expansion of the soda lime silicate vacuum insulating unit glass substrates.

In another aspect, the present disclosure provides a thermally insulating glass panel. In an embodiment, the thermally insulating glass panel comprises one or more spacers according to any embodiment of the present disclosure. In an embodiment, the thermally insulating glass panel comprises a first glass substrate; a second glass substrate, wherein the first glass substrate and the second glass substrate are positioned to define a low-pressure space therebetween, the low-pressure space comprising a pressure less than atmospheric pressure; a plurality of spacers according to any embodiment of the present disclosure disposed between the first glass substrate and the second glass substrate in the low-pressure space, wherein the plurality of spacers are configured to provide strength sufficient to maintain separation of the first glass substrate and the second glass substrate without inducing cracks in a glass substrate surface of the first glass substrate and the second glass substrate; and a hermetic edge or peripheral seal comprising at least one sealing material.

As above, the thermally insulating glass panels or units of the present disclosure comprise a plurality of glass pillars or glass spacers disposed between first and second glass substrates. As used herein, glass pillars or glass spacers refers to pieces or portions of glass, such as chemically strengthened glass, shaped or otherwise configured to be disposed between and separate the glass substrates to define a low-pressure space therebetween. The terms pillars and spacers may be used interchangeably, as used herein.

In an embodiment, the thermally insulating glass panel comprises a plurality of substantially transparent, chemically strengthened glass spacers or pillars provided between the opposing transparent substrates. In an embodiment, the translucent characteristics of the spacers/pillars enable them to be more aesthetically pleasing, while at the same time being strong enough to support the opposing substrates and withstand the applicable forces of atmospheric pressure. In an embodiment, the high compressive strength of the chemically strengthened glass pillars using double (or more) ion exchange processes enable them to be placed farther apart than traditional vacuum insulating unit pillars thereby improving the insulation resistance of the thermally insulating glass panel and thereby reducing manufacturing costs. In an embodiment, the chemically strengthened pillars comprise at least one deep compressive layer extending from the glass surface to a depth of compression of about 40 um up to about 80 um, a linear stress profile from the glass surface to a depth of layer of about 5 um up to about 15 um and a second linear stress profile from the depth of layer to the depth of compression. In an embodiment, the pillar compressive surface stress of the chemically strengthened glass pillar is about 500 MPa or more and the central tension region stress is about 40 MPa to about 90 MPa.

In this regard, attention is directed to FIG. 1 in which thermally insulating glass panel 100 according to an embodiment of the present disclosure is illustrated.

It will be understood that such vacuum insulating unit 100 may be oriented upside down or sideways from the orientations illustrated in FIG. 1. Furthermore, the thickness of the layers and/or size of the components of the unit 100 in FIG. 1 are not drawn to scale or in actual proportion to one another other, but rather are shown as representations.

In FIG. 1, an embodiment of the present disclosure provides a vacuum insulating unit 100 comprising: first glass substrate 102 and second glass substrate 104 defining a low-pressure space 106 therebetween comprising a pressure less than atmospheric pressure. In an embodiment, the first glass substrate 102 and/or the second glass substrate 104 comprise soda lime glass. In an embodiment, the plurality of glass pillars 108 comprises a coefficient of thermal expansion approximately equal to a coefficient of thermal expansion of the first glass substrate 102 and/or the second glass substrate 104.

As shown, the vacuum insulating glass panel 100 further comprises a plurality of pillars 108 disposed between said first and second glass substrates 102 and 104 for spacing said glass substrates 102 and 104 from one another in order to maintain said low-pressure space therebetween. As above, the plurality of glass pillars 108 can include glass pillars 108, such as chemically strengthened glass pillars 108, according to any embodiment of the present disclosure.

In the illustrated embodiment the thermally insulating glass panel 100 comprises a hermetic edge or peripheral seal including at least one sealing material. As shown, the hermetic edge seal 114 comprises a main seal 116 and a primary seal 118 disposed between portions of the main seal 116. The seals are configured to maintain pressure in the low-pressure space 106 at below atmospheric pressure, such as wherein the pressure in the low-pressure space comprises a pressure in a range of about 1*10⁻⁴ torr to about 1*10⁻⁸ torr, for example at approximately 1*10⁻⁷ torr.

The thermally insulating glass panel 100 is shown to further include a sorption getter 126 or equivalent device configured to absorb moisture in the low-pressure space 106.

The thermally insulating glass panel 100 is shown to include a physical pump-out tube 124, pump-out seal 120, and protective cap 122 configured to couple with a pump to create the low-pressure space 106 between the two glass substrates 102 and 104, such as through application of a partial vacuum to the pump-out tube 124.

In the illustrated embodiment, spacers 108 of the plurality of spacers 108 span the low-pressure space 106 between the first glass substrate 102 and the second glass substrate 104, for example, such that a pillar is in contact with a surface 110 of the first glass substrate 102 and also with a surface 112 of the second glass substrate 104. In this regard, the spacers 108 of the present disclosure are configured to hold the first glass substrate 102 and the second glass substrate 104 apart despite the low-pressure space 106 disposed therebetween.

In FIG. 1, an array of such pillars 108 is provided in the low-pressure space 106 of the vacuum insulating unit 100. The spacing or separation of the pillars 108 within the array can vary from 10.0 mm to 100.0 mm depending, for example, on the strength of the pillars 108 and an ability of the plurality of pillars 108 to maintain the less-than-atmospheric pressure in the low-pressure space 106 and physical separation of the two glass substrates 102 and 104 without damaging the glass substrates 102 and 104 surface. In an embodiment, the plurality of pillars 108 is configured to support a pillar array spacing of at least about 40 mm with a chemically strengthened glass pillar 108, such as at least about 50 mm with a glass pillar 108 strengthened prepared with double ion exchange strengthening processes. In an embodiment, a pillar array spacing is in a range of about 60 mm to about 80 mm to reduce the thermal conduction transmitted through the pillar devices placed between the first glass substrate 102 and the second glass substrate 104. With stronger pillars 108, a greater pillar 108 spacing is possible, which further results in greater thermal insulation due to fewer contact points between the pillars 108 and glass substrates 102 and 104.

In an embodiment, all pillars 108 are of approximately the same size and/or material. However, in other embodiments, there may be different sizes of spacers 108 in the same vacuum insulating unit 100. In certain embodiments, the density of spacers 108 (i.e., the number of spacers 108 per unit area) may be greater in certain areas than in other areas, or alternatively, the density of the spacers 108 may be approximately uniform throughout the entire unit 100. The first row or column of pillars 108 may be placed at different distances from the hermetic perimeter edge seal depending on the physical dimensions of the vacuum insulating unit 100 and the strength of the pillar 108. The pillar 108 in this embodiment is capable of supporting a first row or column pillar 108 spacing of at least about 30 mm with a glass pillar 108 strengthened using single ion exchange strengthening processes and at least about 40 mm with a glass pillar 108 strengthened using double ion exchange strengthening processes. The preferred first row or column pillar 108 spacing from the edge of the hermetic perimeter seal is at least about 40 mm to reduce the thermal conduction transmitted through the pillar devices placed between the two glass substrates 102 and 104.

In another aspect, the present disclosure provides a method of chemically strengthening a glass spacer. In an embodiment, the method includes contacting the glass spacer with a salt bath at a salt bath temperature and for a salt bath time sufficient to replace ions, such as lithium ions, in the glass spacer with ions present in the salt bath, such as potassium and sodium ions. As discussed further herein, ion exchange, such as through contacting the glass pillar with a salt bath, may introduce compression in the surface layers of the treated glass. Compression reinforces the glass, which can compensate, in part, for the stress applied to a surface of the chemically strengthened glass.

In certain embodiments, the glass pillar is chemically strengthened using a single ion exchange, which can, in some embodiments, be followed by a chemical soaking step. In an embodiment, the pillar is chemically strengthened using a salt bath comprising a salt bath ratio of about 0% to 5% potassium nitrate (KNO₃) to about 95% to 100% sodium nitrate (NaNO₃), such as with a preferred ratio of 0% KNO₃ and 100% NaNO₃. In an embodiment, the salt bath is pre-heated to between 360 Degrees C and 400 degrees C, such as with a preferred temperature of 380 Degrees C, for about 40 minutes to about 80 minutes, such as with a preferred salt bath exposure time of 60 minutes. In an embodiment, the salt bath temperature setpoint is increased to about 390 Degrees C to about 420 Degrees C, such as with a preferred setpoint temperature of 410 Degrees C, for about 130 minutes to about 170 minutes, such as with a preferred exposure time of 150 minutes. In an embodiment, the pillar is then processed using a chemical soaking step to improve the depth of compression and central tension maximum stress by extending the exposure time for the sodium ions, and, in certain embodiments, potassium ions replacing lithium ions in the pillar. In an embodiment, the glass pillar is chemically soaked in a salt bath comprising a salt bath ratio of about 8% to about 14% potassium nitrate (KNO₃) to about 86% to about 92% sodium nitrate (NaNO₃), such as with a preferred ratio of 11% KNO₃ and 89% NaNO₃. In an embodiment, the salt bath is pre-heated to between 360 Degrees C and 400 degrees C, such as with a preferred temperature of 380 Degrees C, for about 3 minutes to about 5 minutes, such as with a preferred salt bath exposure time of 4 minutes. In an embodiment, the salt bath temperature setpoint is increased to about 380 Degrees C to about 420 Degrees C with a preferred setpoint temperature of 390 Degrees C for about 3 minutes to about 5 minutes with a preferred exposure time of 4 minutes.

In certain embodiments, the glass pillar is chemically strengthened using a single ion exchange. In an embodiment, the pillar is chemically strengthened in a salt bath comprising a salt bath ratio of about 55% to 70% potassium nitrate (KNO₃) to about 30% to 45% sodium nitrate (NaNO₃), such as with a preferred ratio of 60% KNO₃ and 40% NaNO₃. In an embodiment, the salt bath is pre-heated to between 330 Degrees C and 370 degrees C, such as with a preferred temperature of 350 Degrees C, for about 10 minutes to about 20 minutes, such as with a preferred salt bath exposure time of 15 minutes. In an embodiment, the salt bath temperature setpoint is increased to about 360 Degrees C to about 400 Degrees C, such as with a preferred setpoint temperature of 380 Degrees C for about 100 minutes to about 140 minutes, such as with a preferred exposure time of 120 minutes.

In an embodiment, the single ion exchange process produces a glass pillar comprising a compressive surface stress in the range of about 500 MPa to about 650 MPa. In an embodiment, the single ion exchange process produces a glass pillar comprising a depth of compression 5 um to about 15 um. In an embodiment, the single ion exchange process produces a glass pillar comprising a depth of compression of about 40 um to about 80 um. In an embodiment, the single ion exchange process produces a glass pillar comprising a central tension maximum stress of about 40 MPa to about 80 MPa.

While such characteristics may be sufficient for certain applications, such as certain pillar spacings, pillars chemically strengthened by a single ion bath may have insufficient strength, such pillars having a compressive surface stress in the range of about 500 MPa to about 650 MPa, for other applications, such as where a pillar spacing is greater than 40 mm, such as in a pillar spacing range of 60-100 mm. With longer ion exchange times, a depth of layer of exchanged ions (such as sodium, potassium, rubidium, etc.) can be increased. However, with increased depths of compression due to an extended single ion exchange step, an imbalance in surface compression and central tension can be created. This imbalance in surface compression and central tension can lead to an increased chance of rupture when pillars are placed in a vacuum insulated glass panel wherein the glass to pillar induced stress exceeds the yield stress of the pillar. It is common in a vacuum insulating unit for the glass to pillar stress exceeding 900 MPa during wind load and/or thermal deflection.

Accordingly, in an embodiment, and without being bound to any particular theory, it is believed that, in certain embodiments, a single salt bath to chemically treat the glass pillars is insufficient to achieve required strength characteristics. Instead, and as described further herein, the methods of the present disclosure include at least a second salt bath.

To provide glass pillars comprising greater compressive surface stress, such as with balanced surface compression and central tension, in an embodiment, the present disclosure provides a method comprising at least two salt bath ion exchange steps. Accordingly, in an embodiment the method comprises contacting the glass spacer with a first salt bath at a first salt bath temperature and for a first salt bath time sufficient to replace lithium ions in the glass spacer with potassium and sodium ions; and contacting the spacers with a second salt bath at a second salt bath temperature and for a second salt bath time sufficient to replace lithium ions in the glass spacer with potassium ions and sodium ions. The second ion exchange increases the compressive surface stress relative to a single ion exchange. Typical single ion exchange processes yield a compressive surface stress from about 400 MPa to about 600 MPa, while the double ion exchange processes yield a compressive surface stress from about 700 MPa to about 1000 MPa. The second ion exchange imparts a tensile strength of about 650 MPa to about 850 MPa which supports the vacuum load induced stress on the pillar from the glass compressing onto the pillar. If the pillar does not have sufficient tensile strength and/or compressive surface stress the pillar can fail due to the applied stresses exceeding the modulus of rupture of the pillar.

In an embodiment, a ratio of potassium nitrate (KNO₃) to sodium nitrate (NaNO₃) in the first salt bath is greater than in the second salt bath. In this regard, in an embodiment, the first salt bath can comprise more sodium nitrate than the second salt bath.

In an embodiment, the first salt bath comprises a salt bath ratio of about 55% to about 70% potassium nitrate (KNO₃) to about 30% to about 45% sodium nitrate (NaNO₃), wherein the first salt bath temperature is in a range of about 370 degrees C to about 450 degrees C, wherein the first salt bath time is in a range of about 90 minutes to about 150 minutes. In an embodiment, the second salt bath comprises a salt bath ratio of about 90% to about 98% potassium nitrate (KNO₃) to about 2% to about 10% sodium nitrate (NaNO₃), wherein the second salt bath temperature is in a range of about 360 degrees C and 450 degrees C, and wherein a second salt bath time is in a range of about 20 minutes to about 80 minutes.

In an embodiment, the glass pillar is first chemically strengthened using a salt bath ratio of about 55% to 70% potassium nitrate (KNO₃) to about 30% to 45% sodium nitrate (NaNO₃). In an embodiment, the salt bath is pre-heated to between 275 Degrees C and 425 degrees C, such as with a preferred temperature of 350 Degrees C, for about 8 minutes to about 35 minutes, such as with a preferred salt bath exposure time of 20 minutes. In an embodiment, the salt bath temperature setpoint is increased to about 360 Degrees C to about 430 Degrees C, such as with a preferred setpoint temperature of 400 Degrees C, for about 100 minutes to about 160 minutes, such as with a preferred exposure time of 120 minutes. In an embodiment, the glass pillar is then chemically strengthened in a second salt bath comprising a salt bath ratio of about 90% to about 98% potassium nitrate (KNO₃) to 2% to 10% sodium nitrate (NaNO₃). In an embodiment, the second salt bath is pre-heated to between 280 Degrees C and 430 degrees C, such as with a preferred temperature of 370 Degrees C, for about 10 minutes to about 30 minutes, such as with a preferred salt bath exposure time of 20 minutes. In an embodiment, the salt bath temperature is increased to a setpoint between about 360 Degrees C and 420 Degrees C, such as with a preferred setpoint temperature of 380 Degrees C, for about 15 minutes to about 45 minutes, such as with a preferred exposure time of 30 minutes.

In an embodiment, the dual ion exchange process produces a glass pillar comprising a compressive surface stress in the range of about 750 MPa to about 1000 MPa. In an embodiment, the dual ion exchange process produces a glass pillar comprising a Csk or depth of layer of about 5 um to about 20 um. In an embodiment, the dual ion exchange process produces a glass pillar comprising a depth of compression of about 60 um to about 80 um. In an embodiment, the dual ion exchange process produces a glass pillar comprising a central tension maximum stress of about 40 MPa to about 60 MPa. In an embodiment, the dual ion exchange process produces a glass pillar comprising Csk of about 50 MPa to about 150 MPa. In this regard, a dual ion exchange process is suitable to provide glass pillars comprising characteristics configured to allow for greater pillar spacing, such as a pillar spacing of between, for example, 50 mm and 100 mm. Such greater pillar spacing provides better thermal insulation and lower levels of pillar visibility.

In an embodiment, the glass pillar is first chemically strengthened in salt bath comprising a salt bath ratio of about 0% to 5% potassium nitrate (KNO₃) to about 95% to 100% sodium nitrate (NaNO₃). In an embodiment, the salt bath temperature setpoint is about 370 Degrees C and 450 Degrees C, such as with a preferred setpoint temperature of 410 Degrees C, for about 120 minutes to about 180 minutes, such as with a preferred exposure time of 150 minutes. In an embodiment, the glass pillar is then chemically strengthened in a second salt bath comprising a salt bath ratio of about 90% to about 98% potassium nitrate (KNO₃) to 2% to 10% sodium nitrate (NaNO₃). In an embodiment, the salt bath temperature setpoint is between about 400 Degrees C and 500 Degrees C, such as with a preferred setpoint temperature of 440 Degrees C, for about 30 minutes to about 90 minutes, such as with a preferred exposure time of 60 minutes.

In an embodiment, the dual ion exchange process produces a glass pillar comprising a compressive surface stress in the range of about 700 MPa to about 1000 MPa. In an embodiment, the dual ion exchange process produces a glass pillar comprising a Csk or depth of layer of about 5 um to about 10 um. In an embodiment, the dual ion exchange process produces a glass pillar comprising a depth of compression of about 40 um to about 80 um. In an embodiment, the dual ion exchange process produces a glass pillar comprising a central tension maximum stress of about 40 MPa to about 90 MPa. In an embodiment, the dual ion exchange process produces a glass pillar comprising a Csk of about 65 MPa to about 200 MPa.

In an embodiment, the glass pillar is first chemically strengthened in a first salt bath comprising a salt bath ratio of about 0% to 5% potassium nitrate (KNO₃) to about 95% to 100% sodium nitrate (NaNO₃), such as with a preferred ratio of 0% KNO₃ and 100% NaNO₃. In an embodiment, the salt bath is pre-heated to between 360 Degrees C and 420 degrees C, such as with a preferred temperature of 380 Degrees C, for about 40 minutes to about 80 minutes, such as with a preferred salt bath exposure time of 60 minutes. In an embodiment, the salt bath temperature setpoint is increased to about 390 Degrees C to about 440 Degrees C, such as with a preferred setpoint temperature of 410 Degrees C, for about 130 minutes to about 170 minutes, such as with a preferred exposure time of 150 minutes. In an embodiment, the glass pillar is then chemically strengthened in a second salt bath comprising a salt bath ratio of about 96% to about 99% potassium nitrate (KNO₃) and 1% to 4% sodium nitrate (NaNO₃). In an embodiment, the salt bath is pre-heated to between 360 Degrees C and 400 degrees C, such as with a preferred temperature of 380 Degrees C, for about 40 minutes to about 80 minutes, such as with a preferred salt bath exposure time of 60 minutes. In an embodiment, the salt bath temperature is increased to a setpoint between about 420 Degrees C and 460 Degrees C, such as with a preferred setpoint temperature of 440 Degrees C, for about 60 minutes to about 100 minutes, such as with a preferred exposure time of 100 minutes.

In an embodiment, a chemical processing step is provided between the first ion exchange and the second ion exchange to improve the depth of compression and central tension maximum stress of the glass pillar by extending the exposure time for the sodium ions replacing lithium ions in the pillar. In an embodiment, the glass pillar is chemically processed in a salt bath comprising a salt bath ratio of about 6% to about 20% potassium nitrate (KNO₃) to about 80% to about 94% sodium nitrate (NaNO₃), such as with a preferred ratio of 10% KNO₃ and 90% NaNO₃. In an embodiment, the salt bath in the chemical processing step is pre-heated to between 350 Degrees C and 430 degrees C, such as with a preferred temperature of 380 Degrees C, for about 2 minutes to about 10 minutes, such as with a preferred salt bath exposure time of 4 minutes. In an embodiment, the salt bath temperature setpoint in the chemical processing step is increased to about 350 Degrees C to about 440 Degrees C, such as with a preferred setpoint temperature of 400 Degrees C, for about 2 minutes to about 6 minutes, such as with a preferred exposure time of 4 minutes.

In an embodiment, the dual ion exchange process with an intermediate chemical soaking step produces a glass pillar comprising a compressive surface stress in the range of about 700 MPa to about 750 MPa. In an embodiment, the dual ion exchange process with an intermediate chemical soaking step produces a glass pillar comprising a Csk or depth of layer of about 4 um to about 12 um. In an embodiment, the dual ion exchange process with an intermediate chemical soaking step produces a glass pillar comprising a depth of compression of about 50 um to about 80 um. In an embodiment, the dual ion exchange process with an intermediate chemical soaking step produces a glass pillar comprising a central tension maximum stress of about 60 MPa to about 90 MPa. In an embodiment, the dual ion exchange process with an intermediate chemical processing step produces a glass pillar comprising a Csk of about 60 MPa to about 120 MPa.

In an embodiment, the dual ion exchange process with an intermediate chemical processing step produces a glass pillar with a compressive surface stress in the range of about 450 MPa to about 600 MPa. In an embodiment, the dual ion exchange process with an intermediate chemical processing step produces a glass pillar comprising a Csk or depth of layer of about 5 um to about 10 um. In an embodiment, the dual ion exchange process with an intermediate chemical processing step produces a glass pillar comprising a depth of compression of about 50 um to about 70 um. In an embodiment, the dual ion exchange process with an intermediate chemical processing step produces a glass pillar comprising a central tension maximum stress of about 50 MPa to about 80 MPa. In an embodiment, the dual ion exchange process with an intermediate chemical processing step produces a glass pillar comprising a Csk of about 70 MPa to about 100 MPa.

In certain embodiments, the glass pillar is processed using three salt baths, thereby creating three distinct compressive stress zones. In an embodiment, the three compressive stress zones comprise a very high surface compressive stress zone, providing high load strength for the vacuum insulated glass unit, a second intermediate stress zone providing a high rupture performance of the pillar, and a third stress zone of moderate stress to optimize or enhance the CS to CT ratio. In an embodiment, the third zone is provided by a sodium nitrate salt bath, the second stress zone is provided by a potassium nitrate and sodium nitrate salt bath, and the first zone is provided by a potassium nitrate salt bath. In an embodiment, the triple ion exchange process provides a very high compressive surface stress, two knees to the stress profile, CSk₁ and CSk₂, extending the DOC closer to the centerline of the glass pillar and to optimize or enhance the CS to CT ratio. In an embodiment, the three ion exchange steps reduce the degree of plastic deformation of the pillar to less than 4.0 um at a pillar spacing of 60 mm and increase the rupture strength due to the thicker compressive layer.

In an embodiment, the glass pillar is processed using three salt baths, thereby creating three distinct compressive stress zones. In an embodiment, the three compressive stress zones comprise a very high surface compressive stress zone providing high load strength for the vacuum insulated glass unit, a second intermediate stress zone that improves the rupture performance of the pillar, and a third zone of moderate stress to optimize the CS to CT ratio. In an embodiment, the third ion exchange comprises a sodium nitrate salt bath, the second ion exchange comprises a potassium nitrate and sodium nitrate salt bath, and the first ion exchange comprises a rubidium nitrate salt bath. In an embodiment, the triple ion exchange process provides the highest compressive surface stress, with a stress profile comprising two knees, CSk₁ and CSk₂, extends the DOC closer to the centerline of the glass pillar and to optimize or enhance the CS to CT ratio. In an embodiment, the three ion exchange steps reduce the degree of plastic deformation of the pillar to less than 2.0 um at a pillar spacing of 60 mm and increase the rupture strength due to the thicker compressive layer.

In certain embodiments, the glass pillar is processed using three salt baths thereby creating three distinct compressive stress zones. In an embodiment, the three compressive stress zones comprise a very high surface compressive stress zone providing high load strength for the vacuum insulated glass unit, a second intermediate stress zone that improves the rupture performance of the pillar, and a third zone of moderate stress to optimize or to enhance the CS to CT ratio. The third ion exchange comprises a sodium nitrate salt bath, the second ion exchange comprises a potassium nitrate salt bath, and the first ion exchange comprises a rubidium nitrate salt bath. In an embodiment, the triple ion exchange process provides the highest compressive surface stress, a stress profile comprising two knees, CSk₁ and CSk₂, extends the DOC closer to the centerline of the glass pillar, and optimizes or enhances the CS to CT ratio. In an embodiment, the three ion exchange steps reduce the degree of plastic deformation of the pillar to less than 2.0 um at a pillar spacing of 60 mm and increase the rupture strength due to the thicker compressive layer.

In another aspect, the present disclosure provides a glass spacer chemically strengthened according to any method described herein.

In another aspect, the present disclosure provides a thermally insulating glass panel comprising a glass spacer chemically strengthened according to any method of the present disclosure. In an embodiment, the thermally insulating glass panel comprises a first glass substrate; a second glass substrate, wherein the first glass substrate and the second glass substrate are positioned to define a low-pressure space therebetween, the low-pressure space comprising a pressure less than atmospheric pressure; a plurality of spacers chemically strengthened according to any method of the present disclosure and disposed between the first glass substrate and the second glass substrate in the low-pressure space, wherein at least some spacers of the plurality of spacers comprise include chemically strengthened glass that is substantially transparent to at least certain wavelengths of visible light and configured to provide strength sufficient to maintain separation of the first glass substrate and the second glass substrate without inducing cracks in a glass substrate surface of the first glass substrate and the second glass substrate; and a hermetic edge or peripheral seal comprising at least one sealing material.

### EXAMPLES

### Example 1: Chemically Strengthening and Testing Glass Pillars

The present Example demonstrates materials testing of glass pillars and processing of the glass pillars through ion exchanges processes according to embodiments of the present disclosure.

TABLE 1 summarizes material characteristics of glasses tested in the present Example.

TABLE 1
Material characteristics of tested glass

| | Glass 1 | Glass 2 | Glass 3 |
|---|---|---|---|
| Viscosity | | | |
| Softening Point | 721.00 | 880.00 | 760.00 |
| Annealing Point | 517.00 | 635.00 | 540.00 |
| Glass Transition | 506.00 | 615.00 | 525.00 |
| Temperature (Tg) | | | |
| Properties | | | |
| Density | 2.485 | 2.477 | 2.480 |
| Youngs Modulus | 83.00 | 74.00 | 82.00 |
| Poisson's Ratio | 0.225 | 0.215 | 0.220 |
| Shear Modulus | 34.00 | 30.00 | 34.00 |
| Coefficient of | 85.0 × 10 − 7 | 88.0 × 10 − 7 | 83.0 × 10 − 7 |
| Expansion | | | |
| Core Glass IOR | 1.52 | 1.51 | 1.52 |

| | Glass 4 |
|---|---|
| Viscosity | |
| Softening Point | 770.00 |
| Annealing Point | 551.00 |
| Glass Transition Temperature (Tg) | 611 |
| Properties | |
| Density | 2.450 |
| Youngs Modulus | 84 |
| Poisson's Ratio | 0.220 |
| Shear Modulus | 34 |
| Coefficient of Expansion | 72.0 × 10 − 7 |
| Core Glass IOR | 1.52 |

Chemical compositions of various glass materials used herein were tested using Micro and fused bead, XRF, and are summarized in Table 2.

TABLE 2
Composition of glass pillars.

| | Glass 1 | Glass 2 | Glass 3 | Glass 4 |
|---|---|---|---|---|
| | wt % | wt % | wt % | wt % |
| SiO₂ | 69.70 | 69.98 | 54.10 | 63.06 |
| Al₂O₃ | 12.40 | 7.41 | 20.70 | 12.96 |
| Na₂O | 5.31 | 5.22 | 1.95 | 5.70 |
| Li₂O | 3.86 | 7.87 | 0.00 | 0.00 |
| ZrO₂ | 2.11 | 1.04 | 0.01 | 0.84 |
| K₂O | 1.50 | 0.97 | 14.60 | 11.12 |
| Y₂O₃ | 0.00 | 0.00 | 0.00 | 0.00 |
| MgO | 4.71 | 7.12 | 1.52 | 6.24 |
| CaO | 0.23 | 0.25 | 0.02 | 0.06 |
| TiO₂ | 0.17 | 0.13 | 0.01 | 0.01 |
| B₂O₃ | 0.00 | 0.00 | 6.91 | 0.00 |
| SnO₂ | 0.00 | 0.00 | 0.13 | 0.00 |
| Fe₂O₃ | 0.00 | 0.00 | 0.02 | 0.03 |
| BaO | 0.00 | 0.00 | 0.00 | 0.00 |
| SO₃ | 0.00 | 0.00 | 0.00 | 0.00 |
| P₂O₅ | 0.00 | 0.00 | 0.00 | 0.01 |
| NiO | 0.00 | 0.00 | 0.00 | 0.00 |
| Sb₂O₃ | 0.00 | 0.00 | 0.00 | 0.00 |
| Ga₂O₃ | 0.00 | 0.00 | 0.00 | 0.00 |
| CeO₂ | 0.00 | 0.00 | 0.00 | 0.00 |
| PbO | 0.00 | 0.00 | 0.00 | 0.00 |
| ZnO | 0.00 | 0.00 | 0.00 | 0.00 |
| SrO | 0.00 | 0.00 | 0.00 | 0.00 |
| MnO | 0.00 | 0.00 | 0.00 | 0.00 |
| HfO₂ | 0.00 | 0.00 | 0.00 | 0.01 |
| CuO | 0.00 | 0.00 | 0.00 | 0.00 |
| Rb₂O | 0.00 | 0.00 | 0.00 | 0.00 |
| Bi₂O₃ | 0.00 | 0.00 | 0.00 | 0.00 |
| Total | 100.0 | 100.0 | 100.0 | 100.0 |

TABLE 3 summarizes ion exchange processes used to chemically strengthen glass pillars tested in the present Example, according to embodiments of the present disclosure.

TABLE 3
Ion exchange conditions and procedures

| | Glass 1 | Glass 2 | Glass 3 | Glass 4 |
|---|---|---|---|---|
| Chemical Strengthen Step 1 | | | | |
| Step 1 Tank Size (Kg) | 500 | 500 | 500 | 500 |
| Chemical Agent 1 | NaNO₃ | NaNO₃ | NaNO₃ | NaNO₃ |
| Chemical Agent 2 | None | None | None | None |
| Ratio CA 1:CA 2 (wgt. %) | 100% | 100% | 100% | 100% |
| Chemical Agent 3 | None | None | None | None |
| Chemical Agent 3 (Kg) | None | None | None | None |
| Pre-Heat Temperature (Deg C) | None | None | None | 380-400 |
| Pre-Heat Time (min) | None | None | None | 60 |
| Bath Temperature (Deg. C) | 390 | 450 | 410 | 410 |
| Bath Exposure Time (min) | 120 | 150 | 240 | 150 |
| Chemical Processing Step | | | | |
| Soaking Step Tank Size (Kg) | Not Used | Not Used | Not Used | Not Used |
| Chemical Agent 1 | Not Used | Not Used | KNO₃ | NaNO₃ |
| Chemical Agent 2 | Not Used | Not Used | None | KNO₃ |
| Ratio CA 1:CA 2 (wgt. %) | Not Used | Not Used | 100% | 11:89 |
| Pre-Heat Temperature (Deg C) | Not Used | Not Used | Not Used | 380-400 |
| Pre-Heat Time (min) | Not Used | Not Used | Not Used | 3-5 |
| Bath Temperature (Deg. C) | Not Used | Not Used | Not Used | 380-400 |
| Bath Exposure Time (min) | Not Used | Not Used | Not Used | 3-5 |
| Quality Control Specs Step 1 | | | | |
| Compressive Stress (MPa) | 460-600 | 460-600 | 460-600 | 460-600 |
| Depth of Layer (um) | 7.7-9.2 | 7.7-9.2 | 7.7-9.2 | 7.7-9.2 |
| Depth of Compression (um) | 90-105 | 90-105 | 90-105 | 90-105 |
| Compressive Stress Knee (MPa) | 90-130 | 90-130 | 90-130 | 90-130 |
| Central Tension (MPa) | 51-79 | 51-79 | 51-79 | 51-79 |
| Chemical Strengthen Step 2 | | | | |
| Step 2 Tank Size (Kg) | 500 | 500 | 500 | 500 |
| Chemical Agent 1 | None | None | NaNO₃ | NaNO₃ |
| Chemical Agent 2 | KNO₃ | KNO₃ | KNO₃ | KNO₃ |
| Ratio CA 1:CA 2 (wgt. %) | 100% | 100% | 1:99 | 1:99 |
| Pre-Heat Temperature (Deg C) | None | None | None | 380-400 |
| Pre-Heat Time (min) | None | None | None | 60 |
| Bath Temperature (Deg. C) | 460 | 425 | 440 | 440 |
| Bath Exposure Time (min) | 240 | 150 | 60 | 80 |
| Quality Control Specs Step 2 | | | | |
| Compressive Stress (MPa) | 660-830 | 700-1000 | 700-1000 | >700 |
| Depth of Layer (um) | 7.4-9.4 | 7.4-9.4 | 7.4-9.4 | >4 |
| Depth of Compression (um) | 90-105 | 90-130 | 90-130 | >100 |
| Compressive Stress Knee (MPa) | 70-110 | 70-110 | 70-110 | >110 |
| Central Tension (MPa) | 51-81 | 51-81 | 51-81 | <120 |

Glass pillars chemically strengthened by the ion exchange processes summarized in TABLE 3 were tested for physical characteristics pertinent to glass pillars used in the thermally insulating glass panels described herein. These physical characteristics are summarized in TABLE 4.

TABLE 4
Physical characteristics of glass pillars chemically
strengthened through ion exchange.

| Test Parameter | Glass 1 | Glass 2 | Glass 3 | Glass 4 |
|---|---|---|---|---|
| DOL (um) | 6.8 | 6.8-7 | 9.5 | 9.3 |
| DOC (um) | 127.8 | 104-106 | 116 | 115 |
| Cs (MPa) | 852.4 | 872-887 | 845.3 | 885.3 |
| CSk (MPa) | 117.9 | 159-163 | 104.3 | 164.7 |
| CT (MPa) | 106.3 | 84-99 | 64.4 | 87.5 |

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. The term “about” means plus or minus 5% of the stated value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

While illustrative embodiments have been illustrated and described, it will be appreciated that various changes can be made therein without departing from the spirit and scope of the invention.

1. A spacer comprising chemically strengthened glass that is substantially transparent to at least certain wavelengths of visible light,
wherein the spacer comprises a compressive surface stress in a range of about 700 MPa to about 1,000 MPa, and
wherein the spacer comprises a central tension maximum stress in a range of about 40 MPa to about 90 MPa.

2. The spacer of claim 1, wherein the spacer comprises a depth of layer in a range of about 6 um to about 10 um.

3. The spacer of claim 1, wherein the spacer comprises a depth of compression in a range of about 40 um to about 70 um.

4. The spacer of claim 1, wherein the spacer comprises a central tension maximum stress in a range of about 50 MPa to about 80 MPa.

5. The spacer of claim 1, wherein the spacer comprises a CSk in a range of about 70 MPa to about 110 MPa.

6. The spacer of claim 1, wherein the spacer comprises a Mohs hardness of less than 5.0.

7. A thermally insulating glass panel comprising:
a first glass substrate;
a second glass substrate, wherein the first glass substrate and the second glass substrate are positioned to define a low-pressure space therebetween, the low-pressure space comprising a pressure less than atmospheric pressure;
a plurality of spacers according to claim 1 disposed between the first glass substrate and the second glass substrate in the low-pressure space, wherein the plurality of spacers are configured to provide strength sufficient to maintain separation of the first glass substrate and the second glass substrate without inducing cracks in a glass substrate surface of the first glass substrate and the second glass substrate; and
a hermetic edge or peripheral seal comprising at least one sealing material.

8. The thermally insulating glass panel of claim 7, wherein spacers of the plurality of spacers span the low-pressure space between the first glass substrate and the second glass substrate.

9. The thermally insulating glass panel of claim 7, wherein at least some of spacers of the plurality of spacers are transparent to at least about 90% of visible light wavelengths, wherein at least some of spacers of the plurality of spacers comprise an index of refraction of about 1.50.

10. (canceled)

11. (canceled)

12. The thermally insulating glass panel of claim 7, wherein a spacer diameter or spacer width is at least about 1.8 times larger than a spacer height.

13. The thermally insulating glass panel of claim 7, wherein a spacer diameter or spacer width is at least about 0.20 mm to about 1.0 mm, and wherein a spacer height is at least about 0.10 mm to about 0.5 mm.

14. The thermally insulating glass panel of claim 7, wherein a spacer of the plurality of spacers is a disc-shaped device with a diameter of at least about 0.4-mm with a thickness of at least about 0.25-mm.

15. (canceled)

16. The thermally insulating glass panel of claim 7, wherein spacers of the plurality of spacers are arranged in an array of spacers, wherein a spacing or separation of spacers of the plurality of spacers within the array is in a range of about 10.0 mm to about 100.0 mm.

17. (canceled)

18. The thermally insulating glass panel of claim 7, wherein the plurality of spacers comprise an amorphous glass material configured to match a coefficient of thermal expansion of the first glass substrate and the second glass substrate.

19. The thermally insulating glass panel of claim 7, wherein the first glass substrate and second glass substrate comprise soda lime silicate.

20. The thermally insulating glass panel of claim 18, wherein the amorphous glass material comprises: SiO₂ in a range of about 60.0 wt % to about 64.0 wt %; Al₂O₃ in a range of about 29.0 wt % to about 36.0 wt %; P₂O₅ in a range of about 3.0 wt % to about 6.0 wt %; ZnO in a range of about 0.0 wt % to about 2.0 wt %; K₂O in a range of about 0.0 wt % to about 1.0 wt %; and Fe₂O₃ in a range of about 0.0 wt % to about 1.0 wt %, wherein the amorphous glass material comprises a coefficient of thermal expansion in a range of about 7.8×10⁻⁶ to 9.2×10⁻⁶ per degree C; a softening point in a range of about 800 degrees C to 900 degrees C; a glass transition temperature in a range of about 600 degrees C to 650 degrees C; and an annealing point in a range of about 600 degrees C to 670 degrees C.

21. (canceled)

22. The thermally insulating glass panel of claim 18, wherein the amorphous glass material comprises: SiO₂ in a range of about 66.0 wt % and about 72.0 wt %; Li₂O in a range of about 5.0 wt % to 9.0 wt %; Al₂O₃ in a range of about 5.0 wt % to 10.0 wt %; MgO in a range of about 5.0 wt % to 10.0 wt %; Na₂O in a range of about 3.0 wt % to about 7.0 wt %; ZrO₂ in a range of about 0.0 wt % to about 3.0 wt %; K₂O in a range of about 0.0 wt % to about 4.0 wt %; CaO in a range of about 0.0 wt % to 2.0 wt %; and TiO₂ in a range of about 0.0 wt % to about 3.0 wt %, wherein the amorphous glass material comprises a coefficient of thermal expansion in a range of about 7.0×10⁻⁶ to 8.8×10⁻⁶ per degree C; a softening point in a range of about 800 degrees C to 900 degrees C; a glass transition temperature in a range of about 600 degrees C to 650 degrees C; and an annealing point in a range of about 610 degrees C to 650 degrees C.

23. (canceled)

24. The thermally insulating glass panel of claim 7, wherein at least some of plurality of spacers are treated with a double ion exchange comprising sodium nitrate, potassium nitrate or mixtures of sodium nitrate and potassium nitrate to provide a chemically strengthened glass spacer substantially transparent to at least certain wavelengths of visible light, wherein the at least some of the plurality of spacers comprise a depth of potassium penetration of at least about 4 um from an outer surface of the spacers and depth of sodium penetration of at least about 40 um to about 80 um from the outer surface of the spacers.

25. (canceled)

26. (canceled)

27. The thermally insulating glass panel of claim 7, wherein the pressure in the low-pressure space comprises a pressure in a range of about 1*10⁻⁴ torr to about 1*10⁻⁸ torr.

28. (canceled)

29. A method of chemically strengthening a glass spacer, the method comprising:
contacting the glass spacer with a first salt bath at a first salt bath temperature and for a first salt bath time sufficient to replace lithium ions in the glass spacer with potassium and sodium ions; and
contacting the spacers with a second salt bath at a second salt bath temperature and for a second salt bath time sufficient to replace lithium ions in the glass spacer with potassium ions and sodium ions.

30-32. (canceled)

33. A glass spacer chemically strengthened according to a method of claim 29.

34. A thermally insulating glass panel comprising:
a first glass substrate;
a second glass substrate, wherein the first glass substrate and the second glass substrate are positioned to define a low-pressure space therebetween, the low-pressure space comprising a pressure less than atmospheric pressure;
a plurality of spacers according to claim 33 disposed between the first glass substrate and the second glass substrate in the low-pressure space, wherein at least some spacers of the plurality of spacers comprise include chemically strengthened glass that is substantially transparent to at least certain wavelengths of visible light and configured to provide strength sufficient to maintain separation of the first glass substrate and the second glass substrate without inducing cracks in a glass substrate surface of the first glass substrate and the second glass substrate; and
a hermetic edge or peripheral seal comprising at least one sealing material.
